(19) United States
(12) Patent Application Publication
(10) Pub. No.: US 2010/0231164 A1
(43) Pub. Date: Sep. 16, 2010

(54) CHARGING SYSTEM FOR ELECTRIC VEHICLE

(75) Inventor: Chun Suk Yang, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LS INDUSTRIAL SYSTEMS CO., LTD.

(21) Appl. No.: 12/481,531

(22) Filed: Jun. 9, 2009

(30) Foreign Application Priority Data
Mar. 10, 2009 (KR) 10-2009-0020471

(51) Int. Cl. H02J 7/00

(52) U.S. Cl. 320/109

(57) ABSTRACT

An electric vehicle charging system is disclosed, wherein the electric vehicle charging system comprises: a station battery bank storing electric energy; a station battery charging unit changing an AC signal to a DC signal that is supplied for the station battery bank; and a vehicle charging unit charging an electric vehicle with the DC signal from the station battery bank.

### CROSS-REFERENCE TO RELATED APPLICATIONS

The present invention claims priority of Korean patent application number 10-2009-0020471, filed on Mar. 10, 2009, which are incorporated by reference in its entirety.

### BACKGROUND OF THE INVENTION

1. Field of the Invention

The present invention relates to a charging system and particularly, to an electric vehicle charging system.

2. Description of the Related Art

The invention of vehicles such as a car, a truck and a bus has contributed much to betterment of human life. However, those vehicles must use limited resources, i.e., oil. A problem of an environmental pollution occurs in the process of consuming the oil. An electric car that uses electric energy as a fuel has been developed to solve problems about exhaustion of resources, e.g., exhaustion of oil on earth and to develop environment friendly technology.

Today, the electric vehicle technology includes a battery powered electric vehicle, a hybrid electric vehicle, and a fuel cell electric vehicle. The hybrid electric vehicle is powered by a combination of electric and fuel. The battery powered electric vehicle and the hybrid electric vehicle have an internal battery that supplies a power required for operation. Thus, it is required to develop an electric car charging system that supplies electric energy for those vehicles.

A typical electric supplying system being presented is optimized for using domestic electric appliances or operating machineries in factories. If an electric vehicle is supplied of energy from the typical electric supplying system, not only its capacity of electric generation but also infrastructure for electric transmission system must be expanded. Enhancing the capacity of electric generation and the electric transmission system require huge public expenses.

### SUMMARY OF THE INVENTION

According to some exemplary implementations, there is provided an electric vehicle charging system capable of charging of electric vehicles to be substituted for vehicles using oil without additional equipments for supplying electricity.

In one general aspect of the present disclosure, there is provided an electric vehicle charging system, comprising: a station battery bank storing electric energy; a station battery charging unit changing an AC signal to a DC signal that is supplied for the station battery bank; and a vehicle charging unit charging an electric vehicle with the DC signal from the station battery bank.

In another general aspect of the present disclosure, there is provided an electric vehicle charging system, comprising: a station battery bank storing an electric energy; a first switching unit transferring a first electric signal inputted from external; a station battery charging unit changing a second electric signal with the first electric signal transferred by the first switching unit to charge a station battery bank with the second electric signal; a second switching unit transferring a third electric signal supplied from the station battery bank; and a vehicle charging unit charging an electric vehicle with the third electric signal transferred by the second switching unit.

### BRIEF DESCRIPTION OF THE DRAWINGS

FIG. 1 is a block diagram of an electric vehicle.

FIG. 2 illustrates an electric vehicle charging system.

FIG. 3 is a schematic diagram of a vehicle battery charger of FIG. 2.

FIG. 4 is a block diagram of an electric vehicle charging system according to the present invention.

FIG. 5 illustrates an exemplary implementation of an electric vehicle charging system according to the present invention.

FIG. 6 is an exemplary schematic diagram of a station battery charging unit of FIG. 5.

FIG. 7 is an exemplary schematic diagram of a vehicle battery charger of FIG. 5.

### DESCRIPTION OF SPECIFIC EMBODIMENTS

Exemplary implementations of the present disclosure will be described with reference to the accompanying drawings.

FIG. 1 is a block diagram of an electric vehicle.

As shown, the electric vehicle includes a charging terminal 10, a vehicle battery 11, a power relay assembly unit 12, a microprocessor 13, a motor 14, a transmission 15, and tires 16. The charging terminal 10 is a terminal for receiving an electric signal. The electric signal supplied through the charging terminal 10 is stored by the vehicle battery 11. The electric signal stored in the vehicle battery 11 is inputted to the microprocessor 13 through the power relay assembly unit 12. The microprocessor 13 controls a torque and an operation speed of the motor 14. The transmission 15 operates the motor 14 with the electric signal stored in the vehicle battery 11. Mechanical force transferred through the transmission that is mechanically connected to the motor 14 rotates the tires 16.

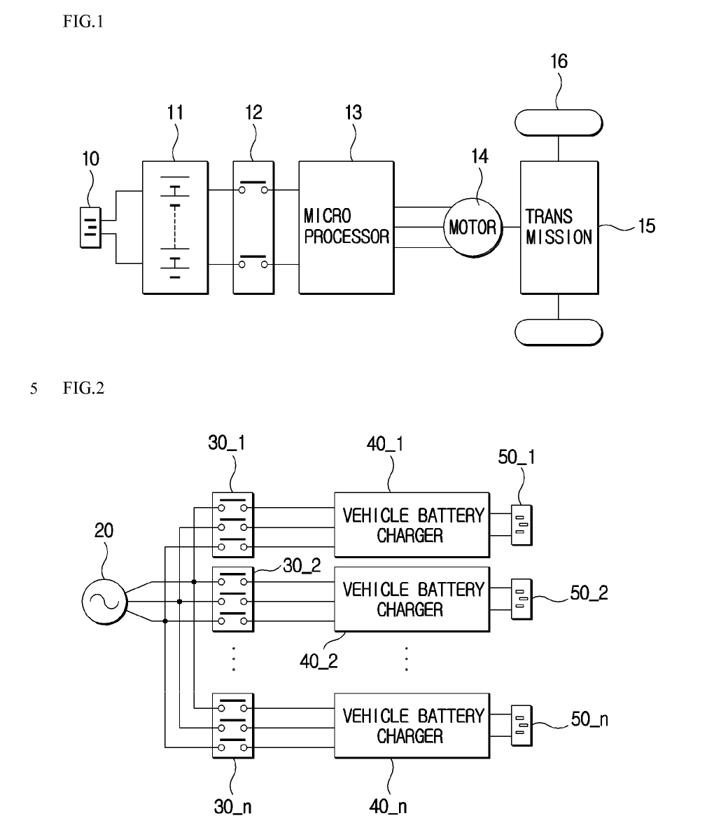

FIG. 2 illustrates an electric vehicle charging system.

As shown, the electric vehicle charging system includes a grid power supplying unit 20, a plurality of electricity transferring units 30_1˜30_n which transfer electric signals, a plurality of vehicle battery chargers 40_1˜40_n and a plurality of charging terminals 50_1˜50_n. The electricity transferring unit 30_1 means a molded case circuit breaker which is widely used. The molded case circuit breaker can close or open a line flowing an electric signal by a manual or an electrical control, and automatically stop the current flow on the line if an overload on the line or another problem occurs. Although it is described that the grid power supplying unit 20 is a power supplier for a three-phase power, the grid power supplying unit 20 may supply a single-phase power.

An electric signal supplied by the grid power supplying unit 20 is transferred to the plurality of vehicle battery chargers 40_1˜40_n through the plurality of electricity transferring units 30_1˜30_n arranged in parallel. The plurality of vehicle battery chargers 40_1˜40_n change AC signals supplied through the plurality of electricity transferring units 30_1˜30_n to DC signals, and provide the DC signals to vehicles through corresponding charging terminals. Since vehicle battery chargers 40_1˜40_n and charging terminals 50_1˜50_n are arranged in parallel, the electric vehicle charging system in FIG. 2 can charge a plurality of vehicles at the same time.

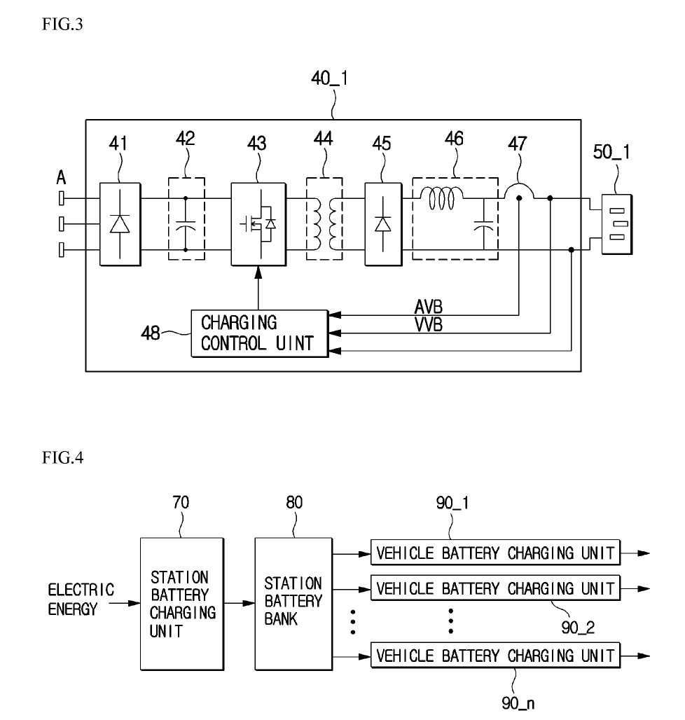

FIG. 3 is a schematic diagram of a vehicle battery charger of FIG. 2. As shown, the vehicle battery charger 40_1 includes a first rectifying unit 41, a smoothing unit 42, a full bridge converting unit 43, a high frequency transferring unit 44, a second rectifying unit 45, a filtering unit 46, a current sensor 47, and a charging control unit 48.

The first rectifying unit 41 rectifies an AC signal supplied through input terminals A to a first DC signal. The smoothing unit 42 smoothes a waveform of the first DC signal from the first rectifying unit 41. The full bridge converting unit 43 converts the first DC signal from the smoothing unit to a high-frequency AC signal by a high-frequency switching operation. The high frequency transferring unit 44 transfers the high-frequency AC signal from the full bridge converting unit 43 to the second rectifying unit 45. The second rectifying unit 45 rectifies the high-frequency AC signal from the high frequency transferring unit 44 to a second DC signal. The filtering unit 46 filters a high frequency factor of the second DC signal rectified by the second rectifying unit 45 to the charging terminal 50_1. The filtering unit 46 includes an LC filter with an inductor and a capacity.

The current sensor 47 measures a current amount of the second DC signal filtered by the filtering unit 46. The charging control unit 48 receives the current amount and a voltage of the second DC signal to control the full bridge converting unit 43 so that a predetermined voltage and current can be transferred to an electric vehicle through the charging terminal 50_1. Because all the vehicle battery chargers 40_1˜40_n have substantially the same configuration, the description for the other vehicle battery chargers 40_2˜40_n except the vehicle battery charger 40_1 is omitted.

As described above, the electric vehicle charging system should have received lots of electric energy from the grid power 20 to charge electric vehicles. To sufficiently supply the electric vehicle charging system with electric energy, the present electricity supplying system must be installed with more electric equipment for supplying electric energy. That is, more electric equipment for generating electric energy is required and power-carrying capacity should be enhanced. The more electric vehicles are supplied, the more the electricity supplying system is enlarged.

Even though electric vehicles may contribute to reduction of consuming fossil fuel and prevention of air pollution, the expansion of the electricity supplying system cannot but cost enormous money since additional electric equipment for supplying electric energy should be installed in order to stably charge electric vehicles. To solve the problem, the present invention suggests an electric vehicle charging system that can reliably charge lots of electric vehicles without additional electric equipment.

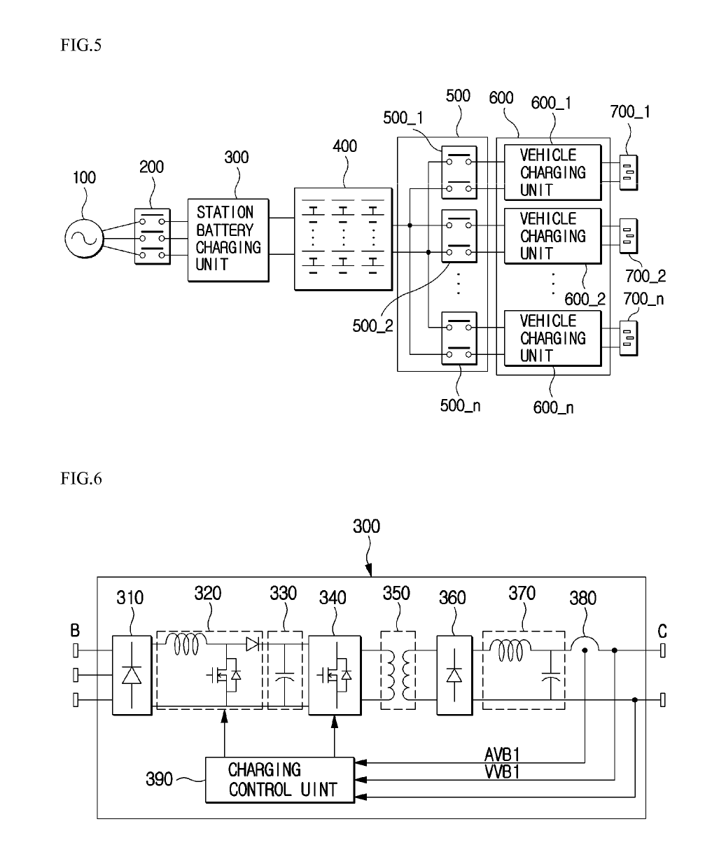

FIG. 4 is an exemplary block diagram of an electric vehicle charging system according to the present invention.

As shown, the electric vehicle charging system includes a station battery charging unit 70, a station battery bank 80, and a plurality of vehicle charging units 90_1˜90_n. The station battery charging unit 70 receives electric energy and supplies the stored electric energy to station battery bank 80. The station battery bank 80 stores the electric energy from the station battery charging unit 70. The vehicle charging unit 90_1 charges an electric vehicle with an electric signal from the station battery bank 80.

The station battery charging unit 70 is characterized by changing an AC signal from the external, i.e. the electric energy, to a DC signal and supplying the AC signal to the station battery bank 80. At least two or more electric vehicle charging units are arranged in order to charge more than two or more vehicles substantially at the same time.

The electric vehicle charging system in FIG. 4 may be characterized by the station battery bank 80 that stores electric energy that means a DC type of an electric signal. Because of that, the station battery charging unit 70 changes an AC signal to a DC signal that is supplied to the station battery bank 80. If an electric vehicle is connected to the vehicle charging units 90_1, the vehicle charging unit 90_1 charges the connected electric vehicle with electric energy supplied from the station battery bank 80. It is possible that the station battery bank 80 receives the AC signal from the external at night during which the requirement and cost of electricity are not relatively high. Thus, since the electric vehicle charging system by the present invention can efficiently use the conventional electricity supplying system, no additional equipment for supplying electricity is required.

FIG. 5 illustrates an exemplary implementation of an electric vehicle charging system according to the present invention.

As shown, the electric vehicle charging system includes a first switching unit 200, a station battery charging unit 300, a station battery bank 400, a second switching unit 500, a vehicle charging unit 600, and charging terminals 700_1˜700_n. The first switching unit 200 transfers a first electric signal from a grid power supplying unit 100 to the station battery charging unit 300. The station battery charging unit 300 charges the station battery bank 400. The station battery bank 400 stores electric energy with a second electric signal from the station battery charging unit 300. The second switching unit 500 transfers a DC signal supplied from the station battery bank 400 to the vehicle charging units 600_1˜600_n. The vehicle charging units 700_1˜700_n charges an electric vehicle with the DC signal transferred by the second switching unit 500.

At least, two or more vehicle charging units are arranged in order to charge two or more vehicles substantially at the same time. The station battery charging unit 300 changes the first electric signal that is an AC signal to the DC signal and charges the station battery bank 400 with the DC signal. The second switching unit 500 includes a plurality of switches that respectively corresponds to the vehicle charging units 600_1˜600_n. The switch of the second switching unit 500, e.g., 500_1, may include any type switching element that can transfer DC signals. The first switching unit may include a molded case circuit breaker and also may include another type of switching element. Although it is described that the grid power supplying unit 100 is a power supplier for a three-phase power, the grid power supplying unit 100 may be a power supplier that can supply a single-phase power.

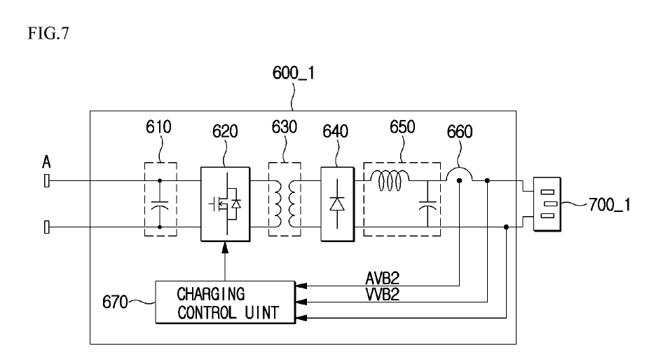

FIG. 6 is an exemplary schematic diagram of the station battery charging unit in FIG. 5.

As shown, the station battery charging unit 300 includes a first rectifying unit 310, a power factor adjusting unit 320, a smoothing unit 330, a full bridge converting unit 340, a high frequency transferring unit 350, a second rectifying unit 360, a filtering unit 370, a current sensor 380, and a charging control unit 390.

The first rectifying unit 310 rectifies the first electric signal that is an AC signal received through an input terminal B. The power factor adjusting unit 320 adjusts a power factor of the first rectified electric signal by the first rectifying unit 310. The smoothing unit 330 smoothes the first rectified electric signal from the power factor adjusting unit 320. The full bridge converting unit 340 converts the first rectified electric signal from the smoothing unit 330 to a high-frequency AC signal. The high frequency transferring unit 350 transfers the high-frequency AC signal from the full bridge converting unit 340. The second rectifying unit 360 rectifies the high-frequency AC signal from the high frequency transferring unit 350 to the filtering unit 370. The filtering unit 370 filters a high frequency factor of the second rectified electric signal rectified by the second rectifying unit to output it through the output terminal C. The filtering unit 370 includes an LC filter.

The current sensor 370 measures a current amount AVB1 of the second rectified electric signal filtered by the filtering unit 370. The charging control unit 390 receives the current amount AVB1 and a voltage VVB1 of the second rectified electric signal to control the power factor adjusting unit 320 and the full bridge converting unit 340 so that an output electric signal outputted by the station battery charging unit 300 can maintain a predetermined voltage and current.

When the first switching unit 200 is turned on, the first rectifying unit 310 rectifies the first electric signal that is the AC signal to an DC signal. The power factor adjusting unit 320 converts the DC signal from the first rectifying unit 310 to a converted DC signal that substantially has a power factor of 1, and charges a capacitor of the smoothing unit 330 with the converted DC signal. The full bridge converting unit 340 generates a high-frequency AC signal with electric charges of the capacitor by a full bridge high-frequency switch operation, and then, transfers the high-frequency AC signal to the high frequency transferring unit 350. The second rectifying unit 360 rectifies the high-frequency AC signal by the high frequency transferring unit 350 to the second rectified electric signal. The filtering unit 370 filters a high frequency factor of the second rectified electric signal to output it through the output terminal C.

The current sensor 370 measures the current amount AVB1 of the second rectified electric signal to provide the current amount AVB1 for the charging control unit 390. Also, the voltage VVB1 of the second rectified electric signal is provided for the charging control unit 390. The charging control unit 390 controls the power factor adjusting unit 320 and the full bridge converting unit 340 with the current amount AVB1 and the voltage VVB1 of the second rectified electric signal so that the output electric signal outputted by the station battery charging unit 300 can maintain a predetermined voltage and current. Because of the feed-back control as described above, the output signal outputted through C can reliably have a predetermined voltage and current.

FIG. 7 is an exemplary schematic diagram of the vehicle battery charger of FIG. 5.

As shown, the vehicle battery charger 600_1 includes a smoothing unit 610, a full bridge converting unit 620, a high frequency transferring unit 630, a rectifying unit 640, a filtering unit 650, a current sensor 660, and a charging control unit 670. The smoothing unit 610 smoothes an electric signal outputted from the station battery charging unit 400. The full bridge converting unit 620 converts the electric signal from the smoothing unit 610 to a high-frequency AC signal. The high frequency transferring unit 630 transfers the high-frequency AC signal from the full bridge converting unit 620. The rectifying unit 640 rectifies the high-frequency AC signal from the high frequency transferring unit 630. The filtering unit 650 filters a high frequency factor of the high-frequency AC signal rectified by the rectifying unit 640.

The current sensor 660 measures a current amount AVB2 of a signal outputted by the filtering unit 650. The charging control unit 670 receiving the current amount AVB2 and a voltage VVB2 of the signal outputted by the filtering unit 650 to control the full bridge converting unit 620 so that a signal outputted by the vehicle charging unit 600_1 can maintain a predetermined voltage and current. The filtering unit includes an LC filter. Because all the vehicle battery chargers 600_1˜600_n have substantially the same configuration, the description of the other vehicle battery chargers 600_2˜600_n except the vehicle battery charger 600_1 is omitted.

As described above, the electric vehicle charging system in FIG. 5 may be characterized by the station battery bank 400 that stores electric energy that means a DC type electric signal. Because of that, the station battery charging unit 300 changes an AC signal to a DC signal that is supplied to the station battery bank 400.

The charging ability of the station battery bank 400 can be decided depending on the arranged place of the electric vehicle charging system or the number of electric vehicles required to be charged. If an electric vehicle is connected to the electric vehicle charging system, the electric vehicle charging system charges the connected electric vehicle with electric energy from the station battery bank 400. It is possible that the station battery bank 400 receives an AC signal from the external at night during which the requirement and cost of electricity are not relatively high. That is, because the station battery bank 400 sufficiently stores electric energy while electricity requirement is relatively low, the electric vehicle charging system by the present invention can efficiently use the present installed electricity supplying system. Although no additional equipments for supplying electricity is installed, by the electric vehicle charging system of the present invention, the conventional electricity supplying system can charge electric vehicles to be substituted for vehicles using oil. Also, the electric vehicle charging system by the present invention can reliably charge electric vehicles without any time limit.

While the present invention has been described with respect to the specific embodiments, it will be apparent to those skilled in the art that various changes and modifications may be made without departing from the spirit and scope of the invention as defined in the following claims.

What is claimed is:

1. An electric vehicle charging system, comprising:
a station battery bank storing electric energy;
a station battery charging unit changing an AC signal to a DC signal that is supplied for the station battery bank; and
a vehicle charging unit charging an electric vehicle with the DC signal from the station battery bank.

2. The electric vehicle charging system of claim 1, further comprising an AC switching unit receiving the AC signal to transfer the AC signal to the station battery charging unit.

3. The electric vehicle charging system of claim 2, further comprising an DC switching unit transferring the DC signal from the station battery charging unit to a vehicle charging unit.

4. The electric vehicle charging system of claim 3, wherein the vehicle charging unit includes at least two vehicle chargers of charging two or more vehicles at one time.

5. The electric vehicle charging system of claim 4, wherein the DC switching unit includes a plurality of DC switches that respectively corresponds to the vehicle chargers.

6. An electric vehicle charging system, comprising:
a station battery bank storing electric energy;
a first switching unit transferring a first electric signal from the external;
a station battery charging unit changing the second electric signal with the first electric signal transferred by the first switching unit to charge the station battery bank with the second electric signal;
a second switching unit transferring a third electric signal supplied from the station battery bank; and
a vehicle charging unit charging an electric vehicle with the third electric signal transferred by the second switching unit.

7. The electric vehicle charging system of claim 6, wherein the station battery charging unit changes the first electric signal that is an AC signal to a DC signal that is supplied for the station battery bank.

8. The electric vehicle charging system of claim 6, wherein the vehicle charging unit includes at least two vehicle chargers for charging two or more vehicles at one time.

9. The electric vehicle charging system of claim 8, wherein the second switching unit includes a plurality of DC switches that respectively corresponds to the vehicle chargers.

10. The electric vehicle charging system of claim 6, wherein the station battery charging unit includes:
a first rectifying unit rectifying the first electric signal that is an AC signal;
a power factor adjusting unit adjusting a power factor of the first rectified electric signal by the first rectifying unit;
a smoothing unit smoothing the first rectified electric signal from the power factor adjusting unit;
a full bridge converting unit converting the first rectified electric signal from the smoothing unit to a high-frequency AC signal;
a high frequency transferring unit transferring the high-frequency AC signal from the full bridge converting unit;
a second rectifying unit rectifying the high-frequency AC signal from the high frequency transferring unit; and
a filtering unit filtering a high frequency factor of the second rectified electric signal rectified by the second rectifying unit.

11. The electric vehicle charging system of claim 10, wherein the station battery charging unit further includes:
a current sensor measuring a current amount of the second rectified electric signal filtered by the filtering unit; and
a charging control unit receiving the current amount and a voltage of the second rectified electric signal to control the power factor adjusting unit and the full bridge converting unit so that the second electric signal outputted by the station battery charging unit maintains a predetermined voltage and current.

12. The electric vehicle charging system of claim 11, wherein the filtering unit includes an LC filter.

13. The electric vehicle charging system of claim 6, wherein the vehicle charging unit includes:
a smoothing unit smoothing an electric signal outputted from the station battery charging unit;
a full bridge converting unit converting the electric signal from the smoothing unit to a high-frequency AC signal;
a high frequency transferring unit transferring the high-frequency AC signal from the full bridge converting unit;
a rectifying unit rectifying the high-frequency AC signal from the high frequency transferring unit; and
a filtering unit filtering a high frequency factor of the high-frequency AC signal rectified by the rectifying unit.

14. The electric vehicle charging system of claim 13, wherein the vehicle charging unit further includes:
a current sensor measuring a current amount of a signal outputted by the filtering unit; and
a charging control unit receiving the current amount and a voltage of the signal outputted by the filtering unit to control the full bridge converting unit so that a signal outputted by the vehicle charging unit maintains a predetermined voltage and current.

15. The electric vehicle charging system of claim 13, wherein the filtering unit includes an LC filter.
